(19) United States
(12) Patent Application Publication
(10) Pub. No.: US 2004/0246564 A1
(43) Pub. Date: Dec. 9, 2004

(54) Novel method for creating frequency converters

(76) Inventor: Chung-Pin Liao, Taichung (TW)

Correspondence Address: BIRCH STEWART KOLASCH & BIRCH, PO BOX 747, FALLS CHURCH, VA, 22040-0747, US

(21) Appl. No.: 10/455,526

(22) Filed: Jun. 6, 2003

(51) Int. Cl. G02F 2/02

(52) U.S. Cl. 359/326

(57) ABSTRACT

A special “standing-laser-poling” method for volumetric domain inversion of nonlinear ferroelectric media, such as LiNbO₃, is provided. Using the combination of a short-wavelength, high-field laser standing wave pattern and a back ground electric field, a short-period bulk domain inversion pattern can be naturally engraved within the nonlinear media.

### FIELD OF THE INVENTION

The invention relates to the general field of achieving short-period volumetric domain inversion of nonlinear media to facilitate frequency conversion processes, with particular reference to the field of second harmonic generation of laser lights.

### BACKGROUND OF THE INVENTION

Nonlinear optics is concerned with the optical properties of matter in intense radiation fields, such as those produced by a laser or a coherent source of EM wave. The optical nonlinearity of a material results from an anharmonic (and usually anisotropic as well) restoring force when an electron is perturbed by an electric field (or electromagnetic field). For example, in lithium niobate (LiNbO₃), the restoring force is stronger for perturbations along the direction of the inbuilt electric field than for perturbations opposed to the inbuilt field. Unlike the situation in linear optical materials at low light intensities, the electromagnetic polarization induced by nonlinear optical materials responds nonlinearly to the electric field of the light. This in turn can give rise to a variety of optical phenomena that can be used to manipulate light, e.g., optical harmonic generation, Raman scattering, parametric amplification, and intensity-dependent refractive indices (see, Neil Broderick's article: “November 2002: Lithium niobate,” Nature Magazine).

Ferroelectric materials, to which lithium niobate belongs, have spontaneous polarization (i.e., inbuilt electric field). That is, these materials have internal electric dipole moments. The direction of these moments can be controlled to form certain desired domain configurations within the ferroelectric media, such as the aforementioned lithium niobate. In this connection, much effort and research have been involved in developing structures having particular domain patterns for optic frequency conversions, in particular the second harmonic generation (SHG) The most popular approach to this end has been the so-called quasi-phase-matching (QPM). It is a technique for phase matching nonlinear optical interactions in which the relative phase between the optic pump wave and the generated second harmonic wave is corrected at regular intervals using a structural periodicity built into the nonlinear media (see FIG. 1A and FIG. 1B). A comprehensive reference is made, for example, to the journal article by Dr. Martin M. Fejer et al.: Quasi-Phase-Matched Second Harmonic Generation: Tuning and Tolerances, IEEE Journal of Quantum Electronics, Vol. 28, No. 11, 1992.

FIG. 1A and FIG. 1B show the effect of phase matching on the growth of second harmonic intensity with the propagating distance in a nonlinear crystal. In FIG. 1A, curve A corresponds to the theoretically perfect phase matching at every point along the light wave propagation direction. Curve C represents the situation of non-phase-matched interaction. Curve B₁ gives the desired first-order QPM by flipping the sign of the spontaneous polarization (Ps) every coherent length (l_{c}) of the interaction curve C. Here the coherent length means the distance over which the phases of the original optical radiation and the generated double-frequency optic radiation slip by 180 degrees and the direction of energy flow reverses (to be further elaborated at equation (1) in the following). Note that when l_{c} is very small, curve B₁ is approaching the ideal curve A. Additionally, in FIG. 1B, with curve A still representing perfect phase matching, curve B₃ reflects the less favorable, low-efficiency conversion situation of third-order QPM by flipping Ps every three coherent lengths.

Much of the interest in second harmonic generation (SHG) is due to the increasing possibility that frequency conversion via domain periodic patterning will provide reliable, inexpensive, and compact sources of desired radiation having adequate energy for its purposes. In particular, much of the current attention is devoted to generating blue optical radiation, of wavelength in the range of about 400-450 nm from a near-IR pump laser, for the realization of next generation (15 GB) DVD (digital video disc) data pickup heads and projection TVs. However, these applications require short-pitched (i.e., short domain inversion period) frequency converters.

Existing domain patterning methods can roughly be divided into two categories, namely, the shallow modulation and the deep (i.e., volumetric) domain inversion. The former can be accomplished by various ways. They are, for example, location-selective electron beam scanning (see [Fujimura M. et al., 1992]), ion beam scanning (see, [Mizuuchi K. and Yamamoto K., 1993]), focused laser beam scanning (see [Daneshvar K. and Kang D. H., 2000]), proton exchange of various details on the nonlinear crystal surface (see [Bortz M. L. et al. 1994], [Yamamoto K. and Mizuuchi K., 1992], U.S. Pat. No. 5,943,465 to Kawaguchi et al. (1999)). Although these shallow approaches can access the much-anticipated short-period (2-4 microns) domain patterning, the resultant active QPM regions are usually of less than 2 microns depth. This makes aligning the active regions with a single-mode optic fiber of normal core diameter of 8-10 microns very hard, and usually necessitates the construction of a waveguide. What's more, due to the resultant non-perpendicular domain walls, the efficiency of such second harmonic generation is always lower than that of the case with a volumetric domain inversion. This invention is in the more favorable category of volumetric domain inversion.

One popular approach to the volumetric domain patterning of a ferroelectric material for quasi-phase-matching (QPM) is by applying an electric field to that material to change the direction of spontaneous polarization at desired locations. This is commonly referred to as the electric field poling or electro-poling (see FIG. 2, wherein a top metal pattern 22 and a bottom metal sheet 21 on the ferroelectric material 23 are biased by the voltage source 20, leading to domain inverted region 12 and non-inverted region 13). There is a long list of prior art related to variations of this method (e.g., U.S. Pat. No. 5,714,198 to Byer et al. (1998), U.S. Pat. No. 5,615,041 to Field et al. (1997)). In this connection, ferroelectric materials to be electro-poled are often sold in bulk form having spontaneous polarization in a single direction, e.g., the dominant spontaneous polarization extends throughout the material from one face to the opposite one. To achieve efficient quasi-phase-matching, namely the first order QPM-SHG (see FIG. 1A and FIG. 1B), adjacent domains are made to be of reversed directions of polarization. This has been routinely accomplished by the large, pulsed electric field in the range of 20-26 kV/mm (e.g., for LiNbO₃), with the width of each domain being about equal to one “coherent length” or period l_{c}, of the desired nonlinear wave interaction within. Here the coherent length means the distance over which the phases of the original optical radiation and the generated double-frequency optic radiation slip by 180 degrees. That is,

Δk·l_{c}=π (1)

where Δk is the difference of wave numbers (k=2π/λ, λ is wave length) between the pump laser and its radiated second harmonic wave within the patterned nonlinear media, and is often called the “mismatch”. With access to smaller period l_{c}, more mismatch is allowed in generating second harmonic light. Hence, it is highly desirable to have short inversion period l_{c} in order to have wide 1^{st}-order QPM-SHG operating window and thus high frequency conversion efficiency.

Two major problems with electric field poling are that it is difficult to provide short period (i.e., small l_{c}) domain inversion patterning and high-resolution domain wall between adjacent domains. The reasons are found to be electric field diffusion in the ferroelectric materials and the hardly avoidable fringe field (see [Kintaka K. et al., 1996]). This is, when a large electric field is applied between two contact electrodes (say, in the vertical direction, see FIG. 2) across a ferroelectric crystal (say, placed horizontally), the electric field distribution tends to broaden (or diffuse) horizontally within the crystal. When one broadened electric field distribution gets too close to another adjacent one, electric arc will occur. This practically limits the formation of volumetric domain inversion to a minimum period of about 6 microns on a piece of, e.g., LiNbO₃ crystal of about 500 microns thickness. As indicated by equation (1), this large period means hard QPM-SHG frequency conversion. In particular, other sources of mismatch arising from electro-poling fabrication error or changes of fundamental wavelength and temperature, etc. can add more detuning effects which further reduce the QPM bandwidth and the SHG conversion efficiency (see [Fejer M. M. et al, 1992] and [Wu J. et al., 1995]).

It is for this reason, Karlsson et al. (U.S. Pat. No. 5,986,798) teaches a doping scheme to increase the resistivity of crystals in an attempt to suppress the electric field diffusion difficulty. However, all existing efforts have not brought satisfactory results. In fact, this is why, up to the present day, we hardly see less-than-6-micron-pitch bulk SHG crystals.

From the application point of view, this poses a severe limit to a lot of frequency converting schemes. For example, 1^{st}-order SHG blue light practically cannot be generated from a bulk lithium niobate of large inversion pitch, and thus people are only left with the less desirable 3^{rd}-order options.

### SUMMARY OF THE INVENTION

It is an object of the invention to provide a method to make short period and efficient frequency converting nonlinear media, including those for frequency doubling and those further as photonic crystals.

Another object of the invention is to provide frequency conversion media for very uniform domain inversion periods and deep active regions and sharp domain walls.

Yet another object of the invention is to provide patterned nonlinear media of suppressed detuning effects, such as in the second harmonic generation.

The invented method uses short-wavelength (e.g., 0.2-4 microns), pulsed high field laser standing wave patterns to realize short-period volumetric domain inversion in the nonlinear media, such as lithium niobate (LiNbO₃). It is this short laser wavelength that will automatically force the domain inversion period within the nonlinear media to be about half the laser wavelength. Note, however, that although the nodes of a standing wave do not change their positions in either time or space, the standing wave amplitude and direction between them do change in time as cos (ωt), where ω(=2πf, f is frequency) is the high-field laser angular frequency. Thus, in order to periodically establish domain inversion within the nonlinear media (e.g., LiNbO₃) using standing laser wave pattern, an extra background field E_{back} is needed. For example, a uniform DC electric field can be applied. That is, suppose the threshold electric field to cause domain inversion in that nonlinear media is Eₜₕ, then to realize the invented method, it is necessary to make both E_{back} and the peak standing wave amplitude Eₒ less than Eₜₕ, respectively; while requiring E_{back} plus E₀ (i.e., when the two point in the same direction) to be greater than or equal to Eₜₕ.

For the existing electro-poling methods, a mask-patterned electric field of about 20-26 kV/mm is applied on LiNbO₃ for about 50 μs to several seconds each time. (The required electric field strength is known to be lower if the treated nonlinear crystal is properly heated.) For the invented standing-laser-poling method, if the chosen laser wavelength is about 1 μm, then existing high-power (1-10 MW) pulsed lasers such as YAG can be employed. Since the laser frequency is in the 1014 Hz range, the invented standing-laser-poling is in fact achieved by repeated poling actions within the applied, say, 10 ms laser pulse duration.

When short-pitch periodic poling can be achieved, another very important category of applications is the manufacturing of so-called photonic crystals. Just as a process-patterned silicon crystal would direct electron flows in a desirable way, a properly patterned photonic crystal would do the same to light. By changing the size, distribution and periodicity of its ferroelectric domains, the properties of a PPLN (periodically poled lithium niobate) crystal, now known as a “designer” material, can be engineered to match the requirement of a given light-manipulation application (see, e.g., Neil Broderick's article: “November 2002: Lithium niobate,” Nature Magazine)

A thorough prior art search concerning laser action and SHG (as well as other frequency converting) crystals has been conducted. All known prior arts are proved to have nothing to do with the invented “standing-laser poling” approach on creating short-pitched frequency converters. Namely, the typical laser setups of those prior arts (including fundamental laser, periodically-inverted crystal, photo-detector, etc.) are either merely for the routine second harmonic generation (SHG) of light wave itself through the already-electrically-poled crystal, or, in extra, as means for monitoring the domain inversion of the crystal (see, e.g., Karlsson et al. U.S. Pat. No. 5,986,798 (1999)). The former is just obtaining the routine quasi-phase-matched (QPM) SHG result once the crystal is properly poled (i.e., periodically domain inverted). The latter is a common practice in checking out the integrity of the poled crystal on a regular basis. None has anything to do with poling the crystal itself using large standing laser action and background DC field, as the current invention teaches.

Chemla et al. (U.S. Pat. No. 4,860,296 Aug. 22, 1989) teaches a multiple-layer heterostructure which is incorporated within the laser resonant cavity to enhance the laser output. Although relating to standing laser wave, it is not relevant as regards to the crystal-poling purpose and subsequent frequency conversions aimed for by the current invention. Besides, having a standing wave within the resonant cavity is just about how a common laser works. In addition, as a side remark, any attempt to manufacture frequency converters using a multi-layer (along the wave propagation direction) approach will prove itself very time consuming and uneconomical.

### BRIEF DESCRIPTION OF THE DRAWINGS

FIG. 1A and FIG. 1B show the effect of phase matching on the growth of second harmonic intensity with propagation distance in a nonlinear crystal.

FIG. 2 illustrates the setup of existing electro-poling method to volumetrically pattern the nonlinear crystal.

FIG. 3 shows the setup of the invented standing-laser-poling method.

FIG. 4A and FIG. 4B illustrates the detailed combined action of the invented standing laser field and the background field.

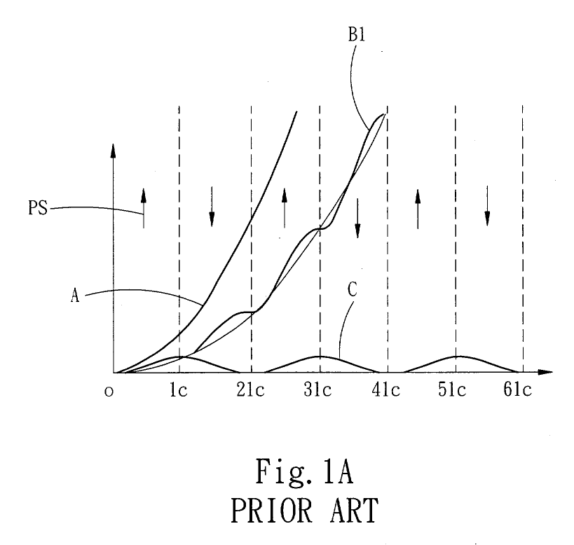

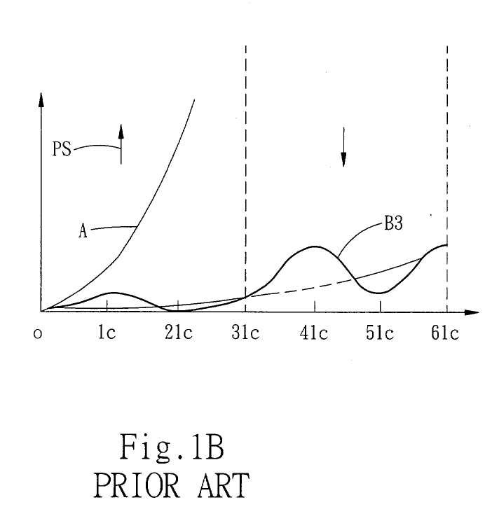

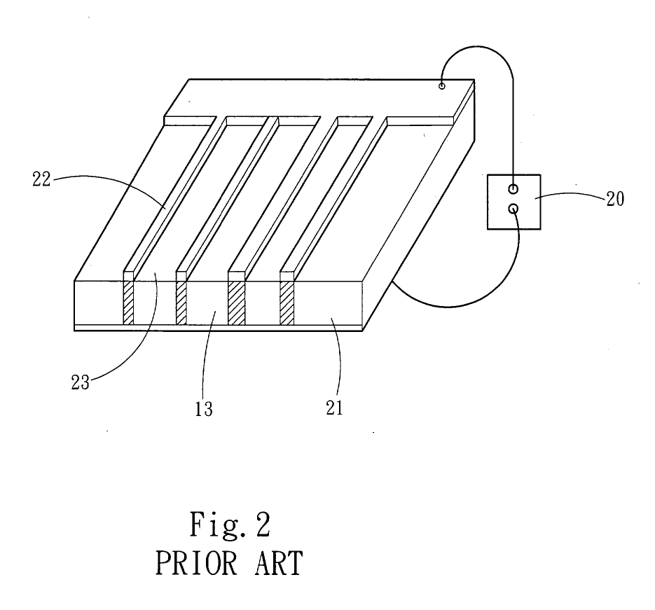

### DESCRIPTION OF THE PREFERRED EMBODIMENTS

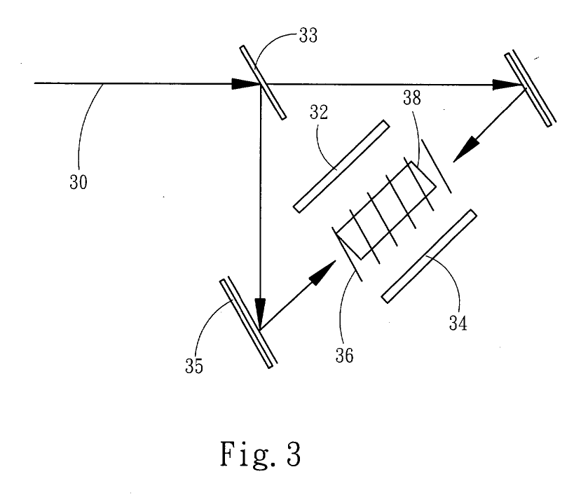

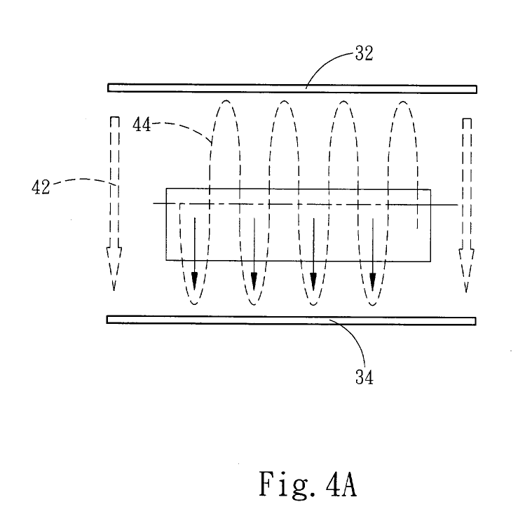

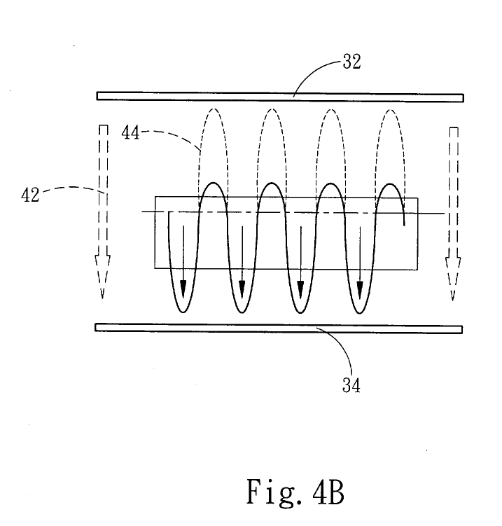

In order to create domain inversion of a desired period 11 within the nonlinear media 38, a standing wave electric field pattern 36 of periodic is needed. This would require a high-field laser 30 of wavelength λ 2·l_{c} together with a background (e.g., constant uniform DC) electric field 42 as illustrated in FIG. 3 and FIG. 4A and FIG. 4B. The background field 42 is realized, for example, by two biased parallel metal plates 32 and 34. Here is an example. If an inversion period of l_{c}≈0.5 μm is desired, then a high-field laser of wavelength λ 1 μm is employed to form a laser standing wave pattern 44, by using a beam splitter 33 and mirrors 35. The desired poling standing wave pattern 36, of period of about 0.5 μm, emerges from the combination of standing wave 44 and background field 42. Though oscillating temporally in amplitude, the poling standing field pattern 36 pulls the nonlinear media to render domain inversion in a patterned fashion every time when reaching its peak field.

The required laser pulse power can be calculated as follows. To realize the invented method, it is necessary to have both the background DC field E_{dc} and the peak standing wave amplitude E₀ less than the threshold field Eₜₕ for domain inversion, respectively, while requiring their sum to be greater than or equal to Eₜₕ. Take LiNbO₃ for an example. If the required threshold electric field to cause domain inversion within LiNbO₃ is 26 kV/mm along a chosen crystal axis and facet, then it can be arranged, for example, such that E_{dc}≈14 kV/mm, and the peak laser electric field E_{dc}≈14 kV/mm, say. There are simply many workable combinations of E_{dc} and E₀ values to carry out the invented method.

The corresponding peak laser power is about E₀H₀A, where the magnetic field intensity H is equal to B/μ₀, in which μ₀ (=4π10⁻⁷ Henry/m) is the magnetic permeability, B is the magnetic flux density, and A is the laser beam cross-sectional area. Assuming TEM wave for the high field laser beam 30 (see the setup in FIG. 3), such that B is equal to E₀/C (C=3108 m/s), and for a beam diameter of D≈1 cm, then the desired laser power is about 35 MW. There are quite a few existing choices for pulsed lasers of this power level and of wavelengths in the 0.2-4 μm range. For example, according to US Naval Research Laboratory's Plasma Formulary (1987) P.50, at least several high-power pulse-type lasers are available:

TABLE 1

| | Wavelength | Pulsed power level |
|---|---|---|
| Type | (μm) | (W) |
| Color Center | 1-4 | >10⁶ |
| Holmium | 2.06 | >10⁷ |
| Iodine | 1.315 | >10¹² |
| Nd-glass, YAG | 1.06 | ˜10¹⁴ |
| Ruby | 0.6943 | 10¹⁰ |
| Kr—F | 0.26 | >10⁹ |
| Xenon | 0.175 | >10⁸ |

In addition, existing compact diode-pumped solid-state (DPSS) lasers, with its high repetition rate (>1 kHz) and high power (≧1 MW), can either be directly applied for the invented purpose or further power amplified by proper pulse compression using existing laser rods (see, [Pasmanik G. A., 2000]).

The created short-period standing wave pattern does not diffuse and broaden within the nonlinear crystal as happens to the existing DC electro-poling method. This is because if the field diffusion problem can also occur with a laser (EM) wave, then any pump laser wave frequency can never be doubled after passing through a frequency doubling crystal. In other words, there would have been no second harmonic generation should the existence of any EM waveform can never be allowed within a domain inverted nonlinear crystal.

The nonlinear media, or crystal, that the invented method can adopt may be LiNbO₃, LiTaO₃, KTiOPO₄ (KTP), KH₂PO₄ (KDP), 2-methyl-4-nitroaniline (mNA) (see [Suhara T. et al., 1993]), β-BaB₂O₄ (BBO), LiB₃O₅ (LBO) (Ding Y. J. et al., 1998), silica fiber (see [Pruneri V. and Kazansky P. G., 1997]), and all other nonlinear materials still under development. Further, the completed frequency-converting nonlinear media can also be employed in the general field of frequency conversion other than the second harmonic generation, for example, the sum and difference frequency generations of interest in the telecommunications area. It should also be noted that, to the best knowledge of the inventor, any thick (>10 μm) volumetric domain inversion with period less than 2 μm, on the most popular LiNbO₃, is practically inaccessible by existing electro-poling methods. The invention thus makes it possible that a large wave number difference (i.e., mismatch), between a pump laser and its second harmonic, so long as it's less than 1.9 micron⁻¹ according to equation (1), can still accomplish frequency doubling on a converter crystal of about 1.6 micron inversion period.

While the invention has been particularly shown and described with reference to the preferred embodiments thereof, it will be understood by those skilled in the art that various changes in form and details may be made without departing from the spirit and scope of the invention. For example, the power of the domain-shaping standing laser wave can be made to be time varying in all kinds of ways. The background DC field can be made slowly varying in both shape and magnitude. Or, the invented patterned optic element can be incorporated into a resonant cavity to generate frequency-altered laser light. Further, due to the large variety of nonlinear physical property of the employed nonlinear crystals, e.g., lithium niobate, from different sources, the needed threshold field for domain inversion can vary in a wide range. It is particularly so if the crystal is being heated while applying the invented method. Lastly, the invented method can be applied on more than one dimension of the nonlinear crystal, for example, for the light focusing purpose.

What is claimed is:

1. A novel method for creating frequency converters by forming periodic domain inversion within a nonlinear media, comprising:
Providing a nonlinear media of a top surface and a bottom surface;
Applying a DC electric field across the top and bottom surfaces of the nonlinear media;
Providing a high field standing wave from high power laser of predetermined wavelength to encompass a proportion of said nonlinear media, with wave electric field perpendicular to the top and bottom surfaces of said nonlinear media, while with said DC field turned on; and
Waiting for a period of time, whereby a frequency conversion element is created.

2. The method of claim 1, wherein the peak sum of said DC field and said laser electric field is greater than a threshold electric field required to cause domain inversion within the nonlinear media, while neither of said DC field and said peak laser electric field is larger in magnitude than said threshold field.

3. The method of claim 2, wherein the threshold electric field is between 5 and 40 kV/mm and said nonlinear media is LiNbO₃.

4. The method of claim 1, wherein the nonlinear media can be selected from ferroelectric materials including LiNbO₃, LiTaO₃, KTiOPO₄, KH₂PO₄, 2-methyl-4-nitroaniline, β-BaB₂O₄, LiB₃O₅, and silica glass, nonlinear magnetic materials.

5. The method of claim 1, wherein the proportion, of the length of said nonlinear media, encompassed by said standing laser wave can vary from 1% to 100%, and said frequency conversion element is used as a photonic crystal.

6. The method of claim 1, wherein the nonlinear media is between 1 micron and 2 cm thick, between 1 micron and 2 cm wide, and between 100 microns and 5 cm long.

7. The method of claim 1, wherein the nonlinear media is kept at room temperature.

8. The method of claim 1, wherein the nonlinear media is further preheated to between 50 and 150 degrees C.

9. The method of claim 1, wherein the high field standing wave is characterized by a predetermined wavelength in the range from 0.2 microns to 4 microns and beam diameter in the range from 0.1 cm to 5 cm.

10. The method of claim 1, wherein the high power laser can be selected from existing technology including color center, Holmium, Iodine, Nd-glass: YAG, Ruby, Kr—F, Xenon, and diode-pumped solid-state (DPSS) lasers.

11. The method of claim 1, wherein the high power laser is operated in pulse mode with duration ranging from 1 pico-second to 100 seconds.

12. The method of claim 1, wherein the high power laser is operated at the power level between 0.1 and 500 MW, and can be varying in time.

13. The method of claim 1, wherein the frequency conversion element is used as a frequency doubling element to convert near IR to blue light.

14. A novel method for creating frequency converters by forming periodic domain inversion within a ferroelectric material, comprising:
Providing a ferroelectric material;
Applying a background electric field of a spatial distribution across a portion of said ferroelectric material;
Providing a high field standing wave of predetermined wavelength to encompass said portion of said ferroelectric material, with said wave electric field along the same line with said background field; and
waiting for a period of time, whereby a frequency converter is created.

15. The method of claim 14, wherein the magnitude and direction of said standing laser wave and said background electric field are both time variables.

16. The method of claim 14, wherein the peak sum of said background electric field and said laser electric field is always greater than a threshold electric field required to cause domain inversion within said ferroelectric material, while both said background electric field and said peak laser electric field are each less in magnitude than said threshold field, respectively.

17. The method of claim 14, wherein the ferroelectric material can be selected from solid compounds including LiNbO₃, LiTaO₃, KTiOPO₄, KH₂PO_{4,2}-methyl-4-nitroaniline, p-BaB₂O₄, and LiB₃O₅.

18. The method of claim 14, wherein the proportion, of the length of said ferroelectric material, encompassed by said standing laser wave can vary from 1% to 100%, and said frequency converter can be used as a photonic crystal.

19. The method of claim 14, wherein the frequency converter is used as a frequency doubling element to convert near IR to blue light, and visible light to UV light.

20. The method of claim 14, wherein the identical procedure is applied on more than one dimension of said ferroelectric material.
